(19) United States
(12) Patent Application Publication
(10) Pub. No.: US 2024/0373897 A1
(43) Pub. Date: Nov. 14, 2024

(54) A COMPOSITION COMPRISING FAT OR OIL DROPLETS AND A METHOD FOR PRODUCING THE COMPOSITION

(71) Applicant: Helsingin yliopisto, Helsingin yliopisto (FI)

(72) Inventors: Fabio Valoppi, Helsingin yliopisto (FI); Ari Salmi, Helsingin yliopisto (FI); Edward Haeggström, Helsingin yliopisto (FI); Kirsi Mikkonen, Helsingin yliopisto (FI); Saman SABET GHADAM HAGHIGHI, Helsingin yliopisto (FI)

(21) Appl. No.: 18/690,713

(22) PCT Filed: Sep. 8, 2022
(86) PCT No.: PCT/FI2022/050602

§ 371 Date: Mar. 8, 2024

(30) Foreign Application Priority Data
Sep. 10, 2021 (FI) 20215956

(51) Int. Cl. A23L 33/24; A23D 7/005; A23D 7/015

(52) U.S. Cl. CPC A23L 33/24; A23D 7/0056; A23D 7/015

(57) ABSTRACT

A composition comprising first solid or semi-solid fat or liquid or viscous oil composition droplets is disclosed. The first solid or semi-solid fat or liquid or viscous oil composition droplets may comprise an at least partially indigestible and/or slowly digestible material, such that the first solid or semi-solid fat or liquid or viscous oil composition in the droplets is at least partially indigestible and/or slowly digestible. The droplets may optionally be dispersed in a second solid or semi-solid fat or liquid or viscous oil composition.

### CROSS-REFERENCE TO RELATED APPLICATIONS

This application is a national stage entry of International Patent Application No. PCT/FI2022/050602 (filed 8 Sep. 2022), which claims priority to Finnish Patent Application No. 20215956 (filed 10 Sep. 2021), the entire disclosures of which are incorporated herein by reference.

### BACKGROUND

### Technical Field

The present disclosure relates to a composition, a method for producing a composition, a food product, and uses thereof.

### Description of Related Art

Oleogels may be used as substitutes for saturated and hydrogenated fat. They have in such capacity been used to reduce the burden of non-communicable diseases such as cardiovascular diseases, type 2 diabetes, and metabolic syndrome. Even though oleogels may be used to deliver essential fatty acids (EFA) that are necessary for human health, they may still have a high caloric content.

Consequently, there may be a need for oleogel compositions and other lipid-based compositions that may not provide such a high caloric content, or which may otherwise assist in controlling or reducing body weight in subjects consuming them.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A composition is disclosed. The composition may comprise first solid or semi-solid fat or liquid or viscous oil composition droplets. The first solid or semi-solid fat or liquid or viscous oil composition droplets may comprise an at least partially indigestible and/or slowly digestible material, such that the first solid or semi-solid fat or liquid or viscous oil composition in the droplets is at least partially indigestible and/or slowly digestible.

### BRIEF DESCRIPTION OF THE DRAWINGS

The accompanying drawings, which are included to provide a further understanding of the invention and constitute a part of this specification, illustrate embodiments and together with the description help to explain the principles of the invention. In the drawings:

FIG. 1 shows a schematic of an embodiment of the composition;

FIG. 2 shows a schematic of another embodiment of the composition;

FIG. 3 shows a schematic of another embodiment of a composition;

FIGS. 4A and 4B show compositions comprising a plurality of capsules;

FIG. 5 shows a schematic presentation of a method to produce the encapsulated lipids (in this case oleogels) in oleogel system;

FIG. 6 shows optical microscopy images of emulsions containing 1% CNC (cellulose nanocrystals), 160 mg NaCl and (A) 10% candelilla oleogel or (B) 10% sunflower oleogel;

FIG. 7 illustrates the droplet size distribution of 10% candelilla oleogel emulsion (dashed line) and 10% sunflower oleogel emulsion (solid line);

FIG. 8 shows (A) sunflower wax oleogel droplets (red) emulsified with cellulose nanocrystals (CNC, blue), (B) magnification of (A) showing oleogel droplets fully covered by CNC (grey, arrow), (C) cryogenic scanning electron microscopy image of oleogel droplets covered by CNC (arrow);

FIG. 9 illustrates the encapsulation efficiency (EE%) of 1:7 CW (candelilla wax), 1:14 CW, 1:21 CW, 1:28 CW, 1:7 SFW (sunflower wax), 1:14 SFW, 1:21 SFW and 1:28 SFW capsules;

FIG. 10 shows crushed capsules for samples having 1:30 CNC:SCF ratio and containing SFW and CW oleogels;

FIG. 11A shows the in vitro digestibility of liquid sunflower oil, oil plus ethylcellulose 5 wt % (viscous oil), cold emulsion (1 wt % HPMC and 10 wt % liquid oil), cold emulsion (1 wt % HPMC and 10 wt % viscous oil), hot HPMC powder (oil:maltodextrin=1:3 wt), and cold HPMC powder (oil:maltodextrin=1:3 wt);

FIG. 11B shows a spray dried powder made of cold emulsion (1 wt % HPMC and 10 wt % liquid oil) and maltodextrin (one portion oil plus three portion maltodextrin);

FIG. 11C shows a composition made of 40 wt % powder and 60 wt % oleogel (oleogel contains 10 wt % monoglyceride); and

FIG. 11D illustrates a composition made of 60 wt % powder and 40 wt % oleogel (oleogel contains 10 wt % monoglyceride).

### DETAILED DESCRIPTION

A composition is disclosed.

The composition may comprise solid or semi-solid fat or liquid or viscous oil composition droplets. The solid or semi-solid fat or liquid or viscous oil composition droplets may be referred to herein as the first solid or semi-solid or liquid or viscous oil composition droplets; the composition may optionally contain at least one further solid or semi-solid fat or liquid or viscous oil composition, such as a second solid or semi-solid fat or liquid or viscous oil composition. The first solid or semi-solid fat or liquid or viscous oil composition droplets may comprise an at least partially indigestible and/or slowly digestible material, such that the first solid or semi-solid fat or liquid or viscous oil composition in the droplets is at least partially indigestible and/or slowly digestible. The droplets (i.e. the first solid or semi-solid fat or liquid or viscous oil composition droplets) may be optionally dispersed in a second solid or semi-solid fat or liquid or viscous oil composition.

The composition may comprise encapsulated first solid or semi-solid fat or liquid or viscous oil composition droplets, wherein the first solid or semi-solid fat or liquid or viscous oil composition droplets are encapsulated in an at least partially indigestible and/or slowly digestible material. The droplets (i.e. the first solid or semi-solid fat or liquid or viscous oil composition droplets) may be optionally dispersed in a second solid or semi-solid fat or liquid or viscous oil composition.

The composition may be a powder, i.e. in the form of a powder; the powder may comprise the (optionally encapsulated) first solid or semi-solid fat or liquid or viscous oil composition droplets. The powder as such may be used for various purposes. Alternatively, the (optionally encapsulated) first solid or semi-solid fat or liquid or viscous oil composition droplets and/or the powder may be dispersed in the second solid or semi-solid fat or liquid or viscous oil composition.

A method for producing a composition according to one or more embodiments described in this specification is also disclosed.

The method may comprise forming droplets comprising a first solid or semi-solid fat or liquid or viscous oil composition;
wherein the droplets are formed in the presence of an at least partially indigestible and/or slowly digestible material, and/or
wherein an at least partially indigestible and/or slowly digestible material is added to the droplets, such that the at least partially indigestible and/or slowly digestible material encapsulates the droplets,
optionally embedding the (optionally encapsulated) droplets in a reinforcing material, and
forming a powder of the (optionally encapsulated) droplets, the powder comprising the (optionally encapsulated) droplets; and
optionally dispersing the powder into a second solid or semi-solid fat or liquid or viscous oil composition.

The method may, in some embodiments, comprise
forming droplets comprising a first solid or semi-solid fat or liquid or viscous oil composition; wherein
the droplets are formed in the presence of an at least partially indigestible and/or slowly digestible material,
optionally embedding the (optionally encapsulated) droplets in a reinforcing material, and
forming a powder of the (optionally encapsulated) droplets, the powder comprising the (optionally encapsulated) droplets; and
optionally dispersing the powder into a second solid or semi-solid fat or liquid or viscous oil composition.

The method may comprise
forming droplets comprising a first solid or semi-solid fat or liquid or viscous oil composition; wherein
an at least partially indigestible and/or slowly digestible material is added to the droplets, such that the at least partially indigestible and/or slowly digestible material encapsulates the droplets,
optionally embedding the encapsulated droplets in a reinforcing material, and
forming a powder of the encapsulated droplets, the powder comprising the encapsulated droplets; and
optionally dispersing the powder into a second solid or semi-solid fat or liquid or viscous oil composition.

The method may, in some embodiments, comprise
forming an emulsion comprising a first solid or semi-solid fat or liquid or viscous oil composition in the form of droplets in water or an aqueous solution; wherein
the emulsion is formed in the presence of an at least partially indigestible and/or slowly digestible material, and/or wherein an at least partially indigestible and/or slowly digestible material is added to the droplets, such that the at least partially indigestible and/or slowly digestible material encapsulates the droplets,
optionally embedding the (optionally encapsulated) droplets in a reinforcing material, and
removing the water or the aqueous solution at least partially, thereby forming a powder comprising the (optionally encapsulated) droplets; and
optionally dispersing the powder into a second solid or semi-solid fat or liquid or viscous oil composition.

The method may, in some embodiments, comprise
forming an emulsion comprising a first solid or semi-solid fat or liquid or viscous oil composition in the form of droplets in water or an aqueous solution; wherein
the emulsion is formed in the presence of an at least partially indigestible and/or slowly digestible material,
optionally embedding the (optionally encapsulated) droplets in a reinforcing material, and
removing the water or the aqueous solution at least partially, thereby forming a powder comprising the (optionally encapsulated) droplets; and
optionally dispersing the powder into a second solid or semi-solid fat or liquid or viscous oil composition.

The method may comprise
forming an emulsion comprising a first solid or semi-solid fat or liquid or viscous oil composition in the form of droplets in water or an aqueous solution; wherein
an at least partially indigestible and/or slowly digestible material is added to the droplets, such that the at least partially indigestible and/or slowly digestible material encapsulates the droplets,
optionally embedding the encapsulated droplets in a reinforcing material, and
removing the water or the aqueous solution at least partially, thereby forming a powder comprising the encapsulated droplets; and
optionally dispersing the powder into a second solid or semi-solid fat or liquid or viscous oil composition.

In the context of this specification, the phrase “the (optionally encapsulated) first solid or semi-solid fat or liquid or viscous oil composition droplets” should be understood as referring to the first solid or semi-solid fat or liquid or viscous oil composition droplets that may or may not be encapsulated, i.e. that are optionally encapsulated (depending e.g. on the embodiment).

The composition may be edible, i.e. suitable for consumption, for example for human consumption.

When the first solid or semi-solid fat or liquid or viscous oil composition droplets are encapsulated, the at least partially indigestible and/or slowly digestible material may form a layer surrounding the droplets, at least partially or completely. Additionally or alternatively, the droplets may be embedded or encapsulated in a reinforcing material, such that the reinforcing material and one or more droplets form a capsule. The at least partially indigestible and/or slowly digestible material may thus function as a covering material or wall material at the surface of the droplets that slows down or prevents the digestion of the encapsulated first solid or semi-solid fat or liquid or viscous oil composition droplets. Additionally or alternatively, the at least partially indigestible and/or slowly digestible material and/or the reinforcing material may form a capsule that slows down or prevents the digestion of the encapsulated first solid or semi-solid fat or liquid or viscous oil composition droplets.

The composition, and specifically the (optionally encapsulated) first solid or semi-solid fat or liquid or viscous oil composition droplets, may thus be at least partially indigestible and/or slowly digestible in the digestive system (of a subject), for example in the human digestive system. In other words, a part of the (optionally encapsulated) first solid or semi-solid fat or liquid or viscous oil composition droplets may be indigestible and/or slowly digestible. Thus, they may travel unaltered or nearly unaltered through the digestive system without being degraded by enzymes, such as lipase(s).

For example, at least 10%, or at least 20%, or at least 30%, or at least 40%, or at least 50%, or at least 60%, or at least 70%, or at least 80%, or at least 90%, or all of the (optionally encapsulated) first solid or semi-solid fat or liquid or viscous oil composition droplets may be indigestible in the digestive system, for example in the human digestive system, or in an in vitro digestion.

The composition, and specifically the (optionally encapsulated) first solid or semi-solid fat or liquid or viscous oil composition or the droplets, may be considered at least partially indigestible in the digestive system, for example in the human digestive system, if for example after digestion at least 30%, or at least 40%, or at least 50%, of the first solid or semi-solid fat or liquid or viscous oil composition droplets that have entered the digestive system can be found in feces after passing through the digestive system. The digestive system may be a human digestive system.

The composition, and specifically the (optionally encapsulated) first solid or semi-solid fat or liquid or viscous oil composition or the droplets, may be considered slowly digestible, if for example they may take at least 8 hours to be digested (e.g. fully digested) during in vitro digestion. In other words, the average time for the (optionally encapsulated) first solid or semi-solid fat or liquid or viscous oil composition droplets to be digested during in vitro digestion may be at least 8 hours. This may be as opposed e.g. to a material that has otherwise a similar composition, but which may take a shorter time, e.g. about 4-5 hours, to digest.

The proportion of the (optionally encapsulated) first solid or semi-solid fat or liquid or viscous oil composition or of the droplets that are indigestible and/or slowly digestible in the digestive system, for example in the human digestive system, may be measured e.g. using an in vitro or an in vivo method. For example, it can be measured by following the release of free fatty acids from the first solid or semi-solid fat or liquid or viscous oil composition during an in vitro digestion (simulated digestion in laboratory). Additionally or alternatively, it may be measured by monitoring the serum triglycerides or lipid fecal content in in vivo animal experiments in which the composition is ingested by the animal. The animal may be a mammal, such as a rodent, or e.g. a human.

The in vitro digestion may be performed e.g. as described in Example 5 below. The in vitro digestion simulates the oral, gastric, and intestinal conditions during human digestion. The in vitro digestion may be carried out using the INFOGEST 2.0 protocol for static in vitro digestion analysis (Brodkorb, A., et al., Nature Protocols, 2019. 14 (4): p. 991-1014). The in vitro digestion method uses simulated digestive fluids and digestive enzymes and is carried out at 37° C. (body temperature). The protocol includes the subsequent addition of different digestive fluids and enzymes during the oral, gastric, and intestinal phases. The fluids used are simulated salivary fluid (SSF), simulated gastric fluid (SGF), and simulated intestinal fluid (SIF). Each fluid has a different ion concertation, composition, and pH value according to the INFOGEST 1.0 and 2.0 protocols (Brodkorb, A., et al., Nature Protocols, 2019. 14 (4): p. 991-1014; Minekus, M., et al., Food & Function, 2014. 5 (6): p. 1113-24). In particular, pH values are 7, 3, and 7 for SSF, SGF, and SIF, respectively may be adjusted using NaOH and HCl. During the oral phase, samples are mixed 1:1 with SSF and salivary amylase is added. This phase lasts for 2 min. Following, the gastric phase is started by mixing to the mixture SGF in 1:1 ratio and pepsin. This phase lasts for 2 h. Finally, the gastric chyme is mixed with SIF in 1:1 ratio and pancreatin (or individual trypsin, chymotrypsin, pancreatic lipase, colipase, and pancreatic amylase) and bile are added to the mixture. This phase lasts for 2 h. During the intestinal phase, during the simulated intestinal phase, triglyceride lipolysis kinetics was analyzed using the pH-stat method (Li, Y. and D. J. McClements, Journal of Agricultural and Food Chemistry, 2010. 58 (13): p. 8085-92). This method measures the fraction of free fatty acids released from triacylglycerols over time by titrating the intestinal chyme with NaOH solution using an automatic titrator.

With such a method, the first solid or semi-solid fat or liquid or viscous oil composition droplets may be considered fully digestible, if they have a similar digestibility as a comparable amount of the same, unstructured (i.e. not contained in a structure or composition that comprises an at least partially indigestible and/or slowly digestible material) fat as the fat (e.g. oil) fraction contained in the first solid or semi-solid fat or liquid or viscous oil composition droplets. The amount of the unstructured fat may be comparable e.g. when the weight of the comparable fat or oil and the weight of the fat fraction contained in the first solid or semi-solid fat or liquid or viscous oil composition droplets are the same. For example, the first solid or semi-solid fat composition or liquid or viscous oil droplets may be considered fully digested, if the proportion of the fat (e.g. oil) fraction of the first solid or semi-solid fat or liquid or viscous oil composition droplets that is digested is at least 95 wt-%, or at least 99 wt-%, of the fraction of the comparable fat or oil that is digested in the in vitro digestion. In other words, the first solid or semi-solid fat or liquid or viscous oil composition droplets may be considered fully digestible, if they have the same or similar digestibility as comparable (bulk, i.e. unstructured) fat (e.g. oil). By way of an example, about 60 wt-% of an unstructured fat, such as oil, may be digested in the in vitro digestion. If at least about 55 wt-%, or at least about 57 wt-%, of the same fat, such as oil, contained in the first solid or semi-solid fat or liquid or viscous oil composition droplets containing a comparable amount of the same fat (e.g. oil) is digested in the in vitro digestion, the first solid or semi-solid fat or liquid or viscous oil composition droplets may be considered fully digested.

The first solid or semi-solid fat or liquid or viscous oil composition and/or the droplets may be considered at least partially digestible, if they have a similar or lower digestibility as a comparable amount of the same, unstructured fat as the fat (e.g. oil) fraction contained in the first solid or semi-solid fat or liquid or viscous oil composition droplets.

The first solid or semi-solid fat or liquid or viscous oil composition and/or the droplets may be considered slowly digestible, if they have a lower digestibility as a comparable amount of the same, unstructured fat as the fat (e.g. oil) fraction contained in the first solid or semi-solid fat or liquid or viscous oil composition droplets. The (optionally encapsulated) first solid or semi-solid fat or liquid or viscous oil composition droplets may be dispersible or re-dispersible in water or an aqueous solution without altering the integrity of the first solid or semi-solid fat or liquid or viscous oil composition droplets. Thus, the first solid or semi-solid fat or liquid or viscous oil composition droplets may be delivered into the intestine, when ingested.

The structure of the (optionally encapsulated) first solid or semi-solid fat or liquid or viscous oil composition droplets, in particular the at least partially indigestible and/or slowly digestible material which may surround the first solid or semi-solid fat or liquid or viscous oil composition droplets, may further stabilize the first solid or semi-solid fat or liquid or viscous oil composition droplets and restrict the access of digestive enzymes, such as lipase(s), to the fat (e.g. oil) fraction contained within the first solid or semi-solid fat or liquid or viscous oil composition droplets. It may also reduce the adsorption of bile salts and colipase onto the first solid or semi-solid fat or liquid or viscous oil composition droplets. Thus, the digestibility of the (optionally encapsulated) first solid or semi-solid fat composition or liquid or viscous oil droplets may be reduced.

The at least partially indigestible and/or slowly digestible, (optionally encapsulated) first solid or semi-solid fat or liquid or viscous oil composition droplets may be delivered to the more distal parts of the gastrointestinal tract of a subject ingesting them, e.g. to the ileum. They may thereby trigger the so-called ileal brake that activates the distal-intestinal hormone and neural signaling that inhibits proximal gastrointestinal motility, gastric emptying, and secretory functions, consequently slowing down the digestive process of the subject. The ileal brake may reduce the daily caloric intake of the subject. It may thereby assist in controlling and/or reducing the body weight of the subject. The composition may not have unpleasant side effects, such as diarrhea. Further, the composition and/or the food product may have a pleasant taste.

The composition, such as the first solid or semi-solid fat or liquid or viscous oil droplets, may be included in various types of food products that may include a fat component.

The first solid or semi-solid fat or liquid or viscous oil composition may comprise or be an oleogel.

The second solid or semi-solid fat or liquid or viscous oil composition may comprise or be an oleogel.

The first solid or semi-solid fat or liquid or viscous oil composition may comprise or be a first oleogel, and the second solid or semi-solid fat or liquid or viscous oil composition may comprise or be a second oleogel. The first and second oleogel may have the same or a similar composition, or they may have different compositions.

Such compositions comprising an oleogel, as the first and/or the second oleogel, may be considered to be oleogel compositions.

In some embodiments, the first solid or semi-solid fat or liquid or viscous oil composition is a (first) liquid or viscous oil composition. The first liquid or viscous oil composition droplets may then be encapsulated in the at least partially indigestible and/or slowly digestible material. Additionally or alternatively, the droplets may be embedded or encapsulated in a reinforcing material, such that the reinforcing material and one or more droplets form a capsule. The droplets may be dispersed in the second solid or semi-solid fat or liquid or viscous oil composition, wherein the second solid or semi-solid fat or liquid or viscous oil composition is an oleogel.

The first solid or semi-solid fat or liquid or viscous oil composition may be first emulsified such that they form the droplets in water or an aqueous solution.

The fat of the first solid or semi-solid fat or liquid or viscous oil composition may be molten before emulsification, and cooled at temperatures below the crystallization temperature of the fat after emulsification to induce crystallization of the droplet core.

In some embodiments, the first solid or semi-solid fat or liquid or viscous oil composition is a first liquid or viscous oil composition. In other words, the fat or oil in the composition may be a liquid oil or a viscous oil. The liquid oil may be liquid at room temperature (at a temperature in the range of 20 to 25° C.). The viscous oil may have a viscosity in the range of about 100 to 20000 mPa·s. The viscosity may be measured e.g. by rotational rheometry or a viscosimeter. The viscosity may be a Brookfield viscosity, as measured with a Brookfield viscometer at a temperature of 20° C., with a vane spindle and a measuring speed of 10 rpm. The apparent viscosity of the viscous oil may be measured with a Brookfield viscometer (Brookfield viscosity) or another corresponding apparatus. Suitably a vane spindle (number 73) is used. There are several commercial Brookfield viscometers available for measuring apparent viscosity, which all are based on the same principle. Suitably a RVDV spring (Brookfield RVDV-III) is used in the apparatus. The temperature of a sample of the viscous oil may be adjusted to 20° C.+1° C. The spindle may be inserted in the sample and the measuring started. The Brookfield viscosity values are given at low rotational speed of 10 rpm.

The droplets may have various dimensions, for example various diameter distributions. The sizes of the droplets may depend e.g. on the first solid or semi-solid fat or liquid or viscous oil composition, on the emulsifying agent, and/or on the method of forming the emulsion (e.g. homogenization parameters). The diameters of the droplets may be within the range of 10 nm to 10 μm, or 100 nm to 50 μm, or 10 nm to 50 μm.

Various options are possible for encapsulating the first solid or semi-solid fat or liquid or viscous oil composition droplets in the at least partially indigestible and/or slowly digestible material, or in more than one partially indigestible and/or slowly digestible materials.

The emulsion may be formed in the presence of the at least partially indigestible and/or slowly digestible material. The at least partially indigestible and/or slowly digestible material may be included as an emulsifying agent when forming the first solid or semi-solid fat or liquid or viscous oil composition droplets, such that the at least partially indigestible and/or slowly digestible material emulsifies or assists in emulsifying the first solid or semi-solid fat or liquid or viscous oil composition droplets. Simultaneously, it may form a layer at the interface of the first solid or semi-solid fat or liquid or viscous oil composition droplets, thereby encapsulating them. Thus the emulsifying agent may function as the at least partially indigestible and/or slowly digestible material, or form a part of the at least partially indigestible and/or slowly digestible material in the composition.

The composition may be formed by forming the droplets such that they comprise an at least partially indigestible and/or slowly digestible material, for example ethylcellulose. In embodiments in which the at least partially indigestible and/or slowly digestible material is ethylcellulose, the first solid or semi-solid fat or liquid or viscous oil composition may be e.g. an oleogel. The at least partially indigestible and/or slowly digestible material and the first solid or semi-solid fat or liquid or viscous oil composition may gel, and droplets may be formed of the gelled at least partially indigestible and/or slowly digestible material and the first solid or semi-solid fat or liquid or viscous oil composition. The droplets thereby obtainable may e.g. be dispersed in the second solid or semi-solid fat or liquid or viscous oil composition. In such embodiments, there may not be a need to have the at least partially indigestible and/or slowly digestible material to encapsulate, or completely encapsulate the droplets. The first solid or semi-solid fat or liquid or viscous oil composition in the droplets may nonetheless be at least partially indigestible and/or slowly digestible.

It may also be possible to form droplets, for example in the case of ethylcellulose and an oleogel gelled, by dropping the liquid fat (e.g. oil) or oleogel (e.g. molten fat or oleogel) from a syringe and allowing it to solidify while it falls down. In such an embodiment, emulsification in the presence of water may not be necessary. It may also be possible to form droplets, for example in the case of ethylcellulose oleogel, by dropping the liquid gel in cold oil and inducing a thermal shock.

Alternatively or additionally, the at least partially indigestible and/or slowly digestible material may be added to the droplets (i.e. after they have been emulsified), such that the at least partially indigestible and/or slowly digestible material encapsulates the droplets. In such embodiments, the droplets may be emulsified in the presence of an emulsifying agent, which does not necessarily have to be (although it may be) an at least partially indigestible and/or slowly digestible material. In such embodiments, the at least partially indigestible and/or slowly digestible material may form e.g. covalent bonds to the emulsifying agent or otherwise be linked to the emulsifying agent.

If the emulsion is formed in the presence of an emulsifying agent that is of an at least partially indigestible and/or slowly digestible material, it may also be possible to add a second at least partially indigestible and/or slowly digestible material to the droplets, such that the emulsifying agent and the second at least partially indigestible and/or slowly digestible material both are at least partially indigestible and/or slowly digestible.

In embodiments in which the composition comprises two or more at least partially indigestible and/or slowly digestible materials, the two or more at least partially indigestible and/or slowly digestible materials may be the same or different (i.e. they may be independently selected e.g. from any at least partially indigestible and/or slowly digestible materials described in this specification).

The emulsifying agent may be solid, such that a socalled Pickering emulsion is formed. In the Pickering emulsion, solid particles of the emulsifying agent may form a layer at the interface of the droplets. The solid particles of the emulsifying agent may thus encapsulate the droplets.

For example, in embodiments in which the emulsifying agent is digestible, it may be possible to gelify the emulsifying agent before forming the emulsion, thereby obtaining portions of micro-or nanogels. Such micro-or nanogels may have their emulsifiability, but because of their gel state, they may be at least partially indigestible and/or slowly digestible. Such emulsifying agents may form a so-called Mickering emulsion of the first solid or semi-solid fat or liquid or viscous oil composition. The micro-or nanogels may cover the surface of the droplet, thereby functioning as an emulsifying agent. An example of such emulsifying agents may be carrageenan.

The at least partially indigestible and/or slowly digestible material, or any at least partially indigestible and/or slowly digestible material described herein (such as an emulsifying agent that is of an at least partially indigestible and/or slowly digestible material, and/or the at least partially indigestible and/or slowly digestible material that may be added to the droplets, and/or the second at least partially indigestible and/or slowly digestible material) may comprise or be cellulose, such as cellulose microand/or nanocrystals; a cellulose derivative, such as methylcellulose, ethylcellulose, carboxymethylcellulose, cellulose amine, and/or hydroxypropylmethylcellulose; resistant modified starch; xylan nanocrystals; chitosan; chitin nanocrystals; a microgel; starch, such as resistant modified starch; protein; alginate; microgelled particles, such as protein or polysaccharide microgel particles; β-glucan; or any mixture or combination thereof. However, other suitable materials may also be contemplated.

The resistant modified starch may be amphiphilic. The resistant modified starch may be e.g. an octenyl succinic anhydride starch, or another alkenyl succinic anhydride starch.

Any solid or semi-solid fat or liquid or viscous oil composition described in this specification may be a lipid-based composition. In addition to a lipid-based or fat component, the first and/or second solid or semi-solid fat or liquid or viscous oil composition may further comprise one or more other components. A main characteristic of solid or semi-solid fat compositions is that they may be self-supporting, i.e., when a container in which they are present is turned upside down, they flow slightly or do not flow at all. This is due to the network of crystals or polymers that may hold their liquid part. Solid fats are usually hard materials that are mainly composed of high proportions of fat crystals.

The first solid or semi-solid fat or liquid or viscous oil composition and its component(s) are not particularly limited. In principle, it may comprise or be saturated fat, unsaturated fat, an oil, a wax, an oleogel, or any combination or mixture thereof. The oil may be liquid, viscous, or semi-solid at room temperature. The first solid or semi-solid fat or liquid or viscous oil composition may comprise a fat-based component and optionally one or more other components. For example, an oleogel may be formed from an oil by adding a structuring agent, i.e. a gelator.

The first solid or semi-solid fat or liquid or viscous oil composition may comprise e.g. a vegetable wax, such as sunflower seed wax, candelilla wax, rice bran wax, and/or carnauba wax, berry wax, flaxseed wax, oat wax, wheat straw wax, apple peel and/or seed wax, rapeseed wax, other wax extracted from plant seeds, fruits and/or plant straw; beeswax; a vegetable oil, such as rapeseed, canola, olive, and/or palm oil; a saturated or unsaturated monoglyceride, a saturated or unsaturated diglyceride, a wax ester (for example, an ester of any wax described above), a fatty alcohol, a fatty acid, a hydroxylated fatty acid, ceramide, lectin, sorbitan tristearate, a sphingolipid, an n-alkane, a phytosterol, such as β-sitosterol, cholesterol, a sterol ester, such as γ-oryzanol, a stanol ester, ethylcellulose, cinnamic acid, a sucrose ester of a fatty acid; or any combination or mixture thereof. For example, the first solid or semi-solid fat or liquid or viscous oil composition may comprise e.g. a vegetable wax and a vegetable oil.

The solid or semi-solid fat in the first solid or semi-solid fat composition may be, additionally or alternatively, a conventional saturated and/or hydrogenated fat. Such fats can be extracted from living organisms or produced through hydrogenation of liquid oils. A solid or semi-solid composition may, in some embodiments, comprise a liquid or viscous oil component, but depending on other components present, the overall structure of the composition may be solid or semi-solid. For example, a mixture or blend of a saturated and/or hydrogenated fat and a liquid oil, or an oleogel formed of a liquid oil, may be considered to be a solid or semi-solid fat composition, if the overall structure of the composition is solid or semi-solid. Or a mixture or blend of a liquid oil and a solid fat may be a liquid or viscous oil, depending e.g. on the proportions of the liquid oil and solid fat in the blend or mixture.
In embodiments in which the droplets are dispersed in the second solid or semi-solid fat or liquid or viscous oil composition, the composition of the second solid or semi-solid fat or liquid or viscous oil composition is not particularly limited. In principle, it may comprise or be saturated fat, unsaturated fat, an oil, a wax, an oleogel, or any combination or mixture thereof.

In embodiments in which the second solid or semi-solid fat or liquid or viscous oil composition is a second liquid or viscous oil composition, the droplets may be dispersed in the second liquid or viscous oil composition. The structure or consistency of the resulting composition depends e.g. on the concentration of the droplets, for example in the form of a powder. If the relative amount of the droplets, for example in the form of a powder, is high, then the second composition can be a liquid oil composition; the second liquid oil composition may then be adsorbed on the powder. Such a product could be used as an ingredient e.g. in foods.

The structure and consistency of the second solid or semi-solid fat or liquid or viscous oil composition may typically affect the overall structure of the composition.

The composition may comprise first oleogel droplets. In other words, in such a composition, the first solid or semi-solid fat or liquid or viscous oil composition is a (first) oleogel composition.

The composition may comprise encapsulated first oleogel droplets, wherein the first oleogel droplets are encapsulated in the at least partially indigestible and/or slowly digestible material. The droplets (i.e. the first oleogel droplets) may be optionally dispersed in a second solid or semi-solid fat or liquid or viscous oil composition, such as in a second oleogel.
E.g. depending on how the composition is formed, one or more of the first solid or semi-solid fat or liquid or viscous oil composition droplets may be included in a capsule. For example, when the emulsion is dried, i.e. when removing the water or the aqueous solution at least partially, thereby forming a powder comprising the encapsulated droplets, capsules comprising one or more of the first solid or semi-solid fat or liquid or viscous oil composition droplets may be formed.

The (optionally encapsulated) first solid or semi-solid fat or liquid or viscous oil composition droplets may, at least some embodiments, be further embedded in a reinforcing material. The reinforcing material may comprise or be e.g. fiber, such as soluble corn fiber and/or soluble wheat fiber (for example, products sold under the trade name _Nutriose FM 06 and FB 06, and Promitor 70); starch, such as resistant modified starch; protein; alginate; β-glucan; carrageenan; a maltodextrin; gum arabic; low methoxyl pectin; high methoxyl pectin; rapid-set pectin; or any mixture or combination thereof. The reinforcing material may be included so as to reinforce the droplets, such that they form capsules and/or do not collapse e.g. during drying (i.e. removing the water or the aqueous solution at least partially, thereby forming a powder comprising the (optionally encapsulated) droplets). The reinforcing material may assist in the formation of the capsules comprising one or more of the first solid or semi-solid fat or liquid or viscous oil composition droplets. The reinforcing material may be at least partially indigestible and/or slowly digestible, or it may be digestible. The droplets may thus be considered to be (optionally) encapsulated in the at least partially indigestible and/or slowly digestible material, or in the reinforcing material, or in both.

The capsules may have various dimensions, for example various diameter distributions. The sizes of the capsules may depend e.g. on the first solid or semi-solid fat or liquid or viscous oil composition, on the emulsifying agent, on the reinforcing material, the ratio of the reinforcing material and of the emulsifying agent, the ratio of the reinforcing material and of the first solid or semi-solid fat or liquid or viscous oil composition, and/or on the method of forming the emulsion (e.g. homogenization parameters, and/or the drying method). The diameters of the droplets may be e.g. within the range of 1 μm to 50 μm, or 5 μm to 100 μm.

It may be possible to obtain the composition without adding a reinforcing material. For example, the droplets may be flocculated and dried. The flocculation may be done e.g. by changing the environmental conditions in the emulsion. In such embodiments, the droplets may be relatively solid (e.g. such that the first solid or semi-solid fat composition comprises mainly solid (saturated) fat, an oleogel with a relatively high proportion of a gelator, or other solid fat composition), such that they retain their shape and do not collapse during the drying.

The droplets may further comprise a gelator. The gelator may be used to form an oleogel (for example, to gel an oil) as the first solid or semi-solid fat or liquid or viscous oil composition prior to forming the droplets. Examples of suitable gelators may include e.g. solid and semi-solid fats or liquid or viscous oil such as palm stearin, shea stearin, super stearin, coconut oil, shea butter, palm oil, silicon oil, castor oil, a medium chain triacylglycerol, other solid or semi-solid fat or liquid or viscous oil, and/or any mixtures or combinations thereof. These may be blended e.g. with other oils.

The components of the first solid or semi-solid fat or liquid or viscous oil composition droplets may be edible.

The mass ratio of the first solid or semi-solid fat or liquid or viscous oil composition and the second solid or semi-solid fat or liquid or viscous oil composition may be in the range of 1-70% (w/w). Additionally or alternatively, the mass ratio may be in the range of 10-60%, or in the range of 20-50% (w/w).

The composition may comprise e.g. at least 50%, or at least 60%, or at least 70%, or at least 80%, or at least 85% (w/w) of total fat.

A food product comprising or prepared from or using the composition according to one or more embodiments described in this specification is also disclosed.

The food product may be a functional food product.

The food product may be e.g. a margarine; a spread; a spreadable chocolate paste; a chocolate-type product; a bakery product; a meat alternative; a dairy alternative; a cheese (such as e.g. cheddar cheese, or a cheese-type product); a plant-based drink (such as a plant milk); or an instant food powder (such as a hot chocolate powder). For example, the spread may be a high-fat or low-fat spread, a chocolate spread, or other spreadable condiment.

The aqueous solution may comprise, in addition to water, e.g. one or more salts, such as NaCl, one or more antioxidants, one or more vitamins, one or more minerals, and/or other components. The components of the aqueous solution may be edible.

The water or the aqueous solution may be removed at least partially using various methods. It may be removed e.g. by spray drying, freeze-drying, spray-freeze-drying, fluid bed drying, vacuum drying, air drying or other suitable drying method.

In an embodiment, the method may comprise:
optionally heating a mixture of an at least partially indigestible and/or slowly digestible material, such as ethylcellulose, and an oil, such that the mixture comprises about 1-6% (w/w), e.g. 5%, of the at least partially indigestible and/or slowly digestible material and about 94-99% (w/w), e.g. 95%, of the oil;
providing a solution of an at least partially indigestible and/or slowly digestible material, such as hydroxypropylmethylcellulose (HPMC);
mixing an oil or the mixture of the at least partially indigestible and/or slowly digestible material, such as ethylcellulose, and an oil, with the solution of the at least partially indigestible and/or slowly digestible material and emulsifying the mixture;
providing a solution of a reinforcing material, such as maltodextrin and/or fibers;
mixing the solution of the reinforcing material and the emulsion and drying, e.g. by spray drying, thereby obtaining a powder.

The powder may be e.g. sieved and collected at room temperature and in dry conditions.

The method may further comprise preparing an oleogel (a second oleogel), e.g. by heating a mixture of an oil with a structuring agent (or gelator), such as a monoglyceride, and subsequently cooling the mixture, thereby obtaining the oleogel. The powder may be mixed with the oleogel, or the powder may be mixed with the mixture of the oil with the structuring agent.

Heating the mixture of the at least partially indigestible and/or slowly digestible material, such as ethylcellulose, and the oil, such that the mixture comprises about 1-6% (w/w), e.g. 5%, of the at least partially indigestible and/or slowly digestible material and about 94-99% (w/w), e.g. 95%, of the oil, may result in a viscous oil composition. The heating may be done such that the mixture is heated to a temperature in the range of about 150-200° C., e.g. to about 180° C., for a suitable time period, such as about 1560 mins. The ethylcellulose should dissolve in the oil, not be a dispersion of ethylcellulose powder in oil.

The solution of the at least partially indigestible and/or slowly digestible material, such as hydroxypropylmethylcellulose (HPMC), may comprise about 1-4% (w/w), or about 1-2% (w/w), of the at least partially indigestible and/or slowly digestible material. The solution may be prepared e.g. by dissolving about 1-4% (w/w), or about 12% (w/w), of the at least partially indigestible and/or slowly digestible material, such as HPMC, in water overnight.

The emulsifying of the mixture of the oil or the mixture of the at least partially indigestible and/or slowly digestible material, such as ethylcellulose, and the oil, and of the solution of the at least partially indigestible and/or slowly digestible material may be done e.g. by mixing with an Ultraturrax at about 13000 rpm for about 2-5 mins. Alternatively, the emulsifying of the mixture may be done e.g. by heating the mixture to a temperature of about 50-90° C. and mixing with an Ultraturrax at about 13000 rpm for about 25 mins. The mixture may comprise e.g. about 5-50% (w/w), or 10-30% (w/w) of the viscous oil composition and about 50-95% (w/w), or about 70-90% (w/w) of the solution of the at least partially indigestible and/or slowly digestible material, such as hydroxypropylmethylcellulose (HPMC).

The solution of the reinforcing material, such as maltodextrin and/or fibers, may comprise about 10-40 (w/w), such as 25%, of the reinforcing material.

Mixing the solution of the reinforcing material and the emulsion may be done by mixing them shortly before the drying and such that they are mixed at a weight ratio of about 5:1 to 0.5:1, e.g. about 3:1. Optionally they may be heated to a temperature of about 50-90° C., e.g. 70° C., before the mixing.

The drying, e.g. by spray drying, may be done by spray drying using an inlet temperature of 170° C., 100% aspiration, 35-55% pump speed.

The oleogel (the second oleogel) may be prepared e.g. by heating the mixture of an oil with a structuring agent, such as a monoglyceride, to a temperature of about 60-100° C., e.g. 80°° C., for about 2-60 minutes, or about 5-10 minutes, and subsequently cooling the mixture, thereby obtaining the oleogel. The amount of the structuring agent, such as the monoglyceride, may be about 2.5-20% (w/w), or about 5-10% (w/w), of the total weight of the mixture of the oil and the structuring agent.

The powder may be mixed with the oleogel such that the amount of the powder is in the range of about 5-70% (w/w), or about 40-60% (w/w) of the mixture of the powder and the oleogel. In embodiments in which the oleogel (the second oleogel) is prepared by heating the mixture of an oil with a structuring agent, prior to the mixing, the powder may be heated to a temperature of about 60-100° C., or about 80° C., and added to the mixture of the oil with the structuring agent prior to cooling the mixture (i.e. when it is molten).

The composition may be a pharmaceutical composition.

The composition may be provided as such, e.g. as a food supplement. The food supplement may be e.g. in the form of a powder. The food supplement may be packed in single-dose pouches. The composition, such as the food supplement, may be consumed before eating (e.g. before a meal).

The composition may, additionally or alternatively, be provided in a dosage form, for example as a pill or capsule. An example of such a pill of capsule could be one including the composition in the form of a liquid oil inside.

The composition, such as a pharmaceutical composition, may include one or more additional agents, such as drugs. They could be included e.g. such that they be released in a target part of the digestive tract.

The pharmaceutical composition may further comprise a pharmaceutically acceptable carrier. Examples of suitable pharmaceutically acceptable carriers are well known in the art and may include e.g. phosphate buffered saline solutions, water, oil/water emulsions, wetting agents, and liposomes. Compositions comprising such carriers may be formulated by methods well known in the art. The pharmaceutical composition may further comprise other components such as vehicles, additives, preservatives, other pharmaceutical compositions administrated concurrently, and the like.

The pharmaceutical composition may comprise an effective amount of the active agent, for example of the first solid or semi-solid fat or liquid or viscous oil composition droplets. The effective amount may be a therapeutically effective amount. The therapeutically effective amount may be selected in accordance with a variety of factors, including the age, weight, sex, diet and medical condition of the subject to which the composition is administered.

The pharmaceutical composition may be a composition for oral administration.

The composition according to one or more embodiments described in this specification or the food product according to one or more embodiments described in this specification for use in activating the ileal brake in a subject, and/or in controlling and/or reducing the body weight of the subject, is also disclosed.

Use of the composition according to one or more embodiments described in this specification or the food product according to one or more embodiments described in this specification for controlling and/or reducing the body weight of a subject is further disclosed. The use may be cosmetic and/or non-therapeutic. The composition may thus be a cosmetic and/or a non-therapeutic composition.

The composition or the food product may, additionally or alternatively, be used e.g. in controlling appetite.

### EXAMPLES

Reference will now be made in detail to various embodiments, an example of which is illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

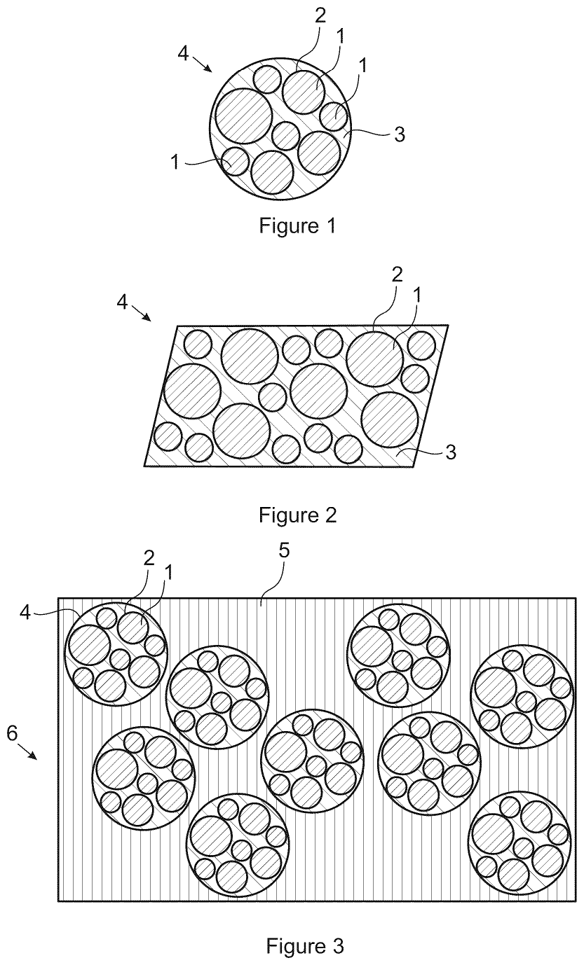

FIG. 1 shows a schematic of an embodiment of the composition. In this embodiment, a number of spherical or essentially spherical first solid or semi-solid fat or liquid or viscous oil composition droplets 1, for example one, two or more droplets or a plurality of droplets, are encapsulated by an at least partially indigestible and/or slowly digestible material 2. The at least partially indigestible and/or slowly digestible material 2 may form a layer surrounding the droplets 1, at least partially or completely. The droplets 1 may be of different diameters. The first solid or semi-solid fat or liquid or viscous oil composition in the droplets 1 may comprise or be e.g. an oleogel, but any other solid or semi-solid fat or liquid or viscous oil compositions described in this specification may also be contemplated.

The droplets 1 are embedded in a reinforcing material 3, such that the reinforcing material 3 and the droplets 1 form a capsule 4. In this embodiment, the capsule 4 is spherical or essentially spherical, and the capsule 4 is depicted as a cross-section. Such capsules may be obtainable e.g. by spray drying. In the spray drying, an aerosol of an emulsion comprising the droplets, for example in the presence of the reinforcing material, may be sprayed in hot air, such that the water or aqueous solution in the aerosol of the emulsion may evaporate, such that solid capsules 4 may be formed. Capsules thereby obtainable may be mainly spherical.

FIG. 2 shows a schematic of another embodiment of the composition. This embodiment is similar to the one depicted in FIG. 1, except that the capsule 4 has a parallelepipedal shape. Capsules with such shapes may be obtainable e.g. by freeze-drying. During the freeze-drying of the emulsion, a solid material may be obtained and thereafter crushed, resulting in mainly parallelepipedal shapes of the capsules.

However, various other three-dimensional shapes may also be contemplated for the capsule, for example various regular and/or irregular polyhedral shapes, substantially ellipsoid, substantially cuboid, substantially a cube, substantially cylindrical, substantially tubular, grain-shaped or an irregular shape.

FIG. 3 shows a schematic of another embodiment of a composition 6. In this embodiment, capsules 4 similar to those depicted in FIG. 1 are embedded in a dispersed in a second solid or semi-solid fat or liquid or viscous oil composition 5, thereby forming the composition 6. Although the capsules 4 are spherical, any other capsules, such as e.g. similar those depicted in FIG. 2, could, additionally or alternatively, be dispersed in the second solid or semi-solid fat or liquid or viscous oil composition 5.

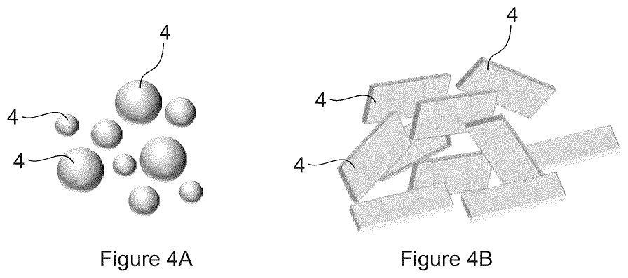

FIG. 4A shows a composition comprising a plurality of capsules 4, which are spherical or essentially spherical. The capsules 4 may be similar to those shown in FIG. 1. The capsules 4 may be e.g. in the form of a dry powder. Although not shown in this Fig., the plurality of capsules 4 could alternatively be dispersed in a second solid or semi-solid fat or liquid or viscous oil composition, such as in a second oleogel.

FIG. 4B shows a composition comprising a plurality of capsules 4, which are parallelepipedal or essentially parallelepipedal. The capsules 4 may be similar to those shown in FIG. 2. The capsules 4 may be e.g. in the form of a dry powder. Although not shown in this Fig., the plurality of capsules 4 could alternatively be dispersed in a second solid or semi-solid fat or liquid or viscous oil composition, such as in a second oleogel.

### Example 1

An oleogel composition was prepared according the following steps: (i) formation of emulsions containing oleogels; (ii) formation of capsules containing oleogel droplets; and (iii) dispersion of capsules in a second oleogel. In steps (i) and (ii), the emulsifier used to form the emulsions and the reinforcing material used in the formation of capsules was indigestible or had reduced digestibility.

The oleogel used in the first step contained 2-5% vegetable wax such as sunflower, candelilla, rice bran, or carnauba wax; the remaining part was rapeseed oil. After melting, the oleogel was emulsified to obtain droplets with 0.1-10 μm diameter using 1-5% indigestible particles (such as cellulose nanocrystals [CNC], regenerated chitin particles, or resistant modified starch). The materials employed for covering the interface of oleogel droplets represent the first barrier to reduce the digestibility of oleogels. Then, the emulsion was mixed with 5-40% secondary wall materials that allow robust multi-core capsules to be obtained, such as soluble corn fiber, resistant starch, alginate, or maltodextrins. The emulsion was thereby cooled down to induce crystallization of the waxes and to form an oleogel in the droplets. For the alginate-containing mixture, spherification using calcium chloride was performed to obtain beads incorporating oleogel droplets with reduced digestibility. Then, the mixtures and beads were spray-dried, freeze-dried, vacuum-dried, or air-dried to obtain powder materials with a particle size of 5-50 μm (possible grinding can be necessary after some of the drying techniques to obtain a powder material). Depending on the drying technique and wall materials, capsule morphologies and packing of wall materials (at oleogel droplet surface) could be tailored. Capsule morphologies can be spherical or parallelepipedal depending on drying technique (spray drying vs. freeze drying after grinding). Wall material packing can be compact (in case of e.g. spray-dried CNC stabilized emulsions) or porous (in case of e.g. freeze dried microgel stabilized emulsions).

Next, the powder was dispersed into a second molten oleogel containing monoglycerides, fatty alcohols, fatty acids or the same waxes used for preparing the first oleogel at a concentration of 2.5-10%. Finally, the system was cooled at room temperature to trigger the crystallization of the outer oleogel.

### Example 2

The materials used for obtaining the internal oleogels were sunflower seed wax (SFW) or candelilla wax (CW) and rapeseed oil, emulsifying agents were cellulose nanocrystals (CNC) or resistant modified starch, the external wall material for obtaining the capsules was soluble corn fiber (SCF). External oleogel was obtained using monoglycerides (MG) and rapeseed oil. Additional ingredients were sodium chloride and water.

All oleogels were at concentration of 5% (w/w) gelator in rapeseed oil. Emulsions contained 10% oleogels and 1% CNC (additionally we used 160 mg NaCl/g CNC).

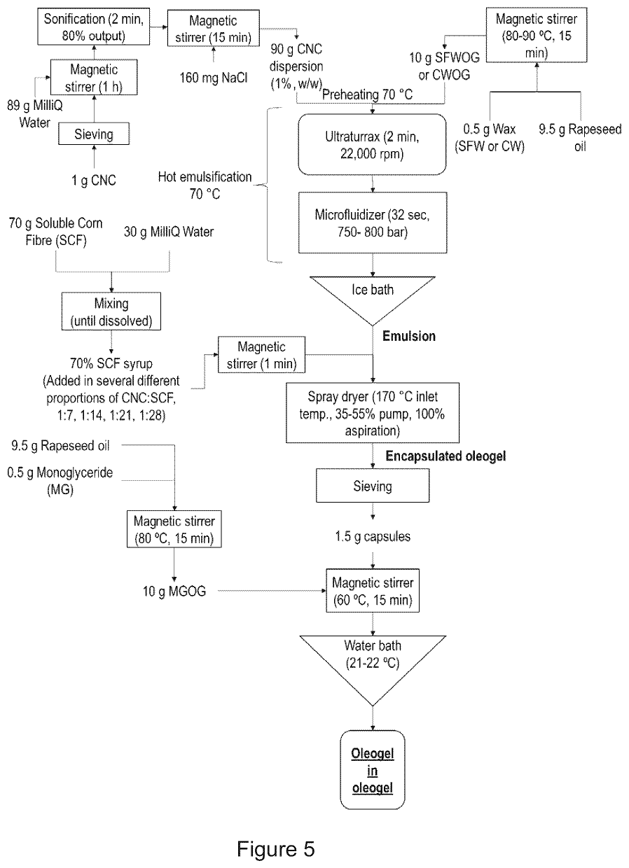

A schematic presentation of the method to produce the encapsulated lipids (in this case oleogels) in oleogel system is shown in FIG. 5.

### Pickering Oleogel Emulsions

First, Pickering oleogel emulsions were developed, where the dispersed phase was an oleogel containing 5% SFW or CW in rapeseed oil, stabilized using CNC. The emulsions were formed successfully and resulted stable soon after production and during storage.

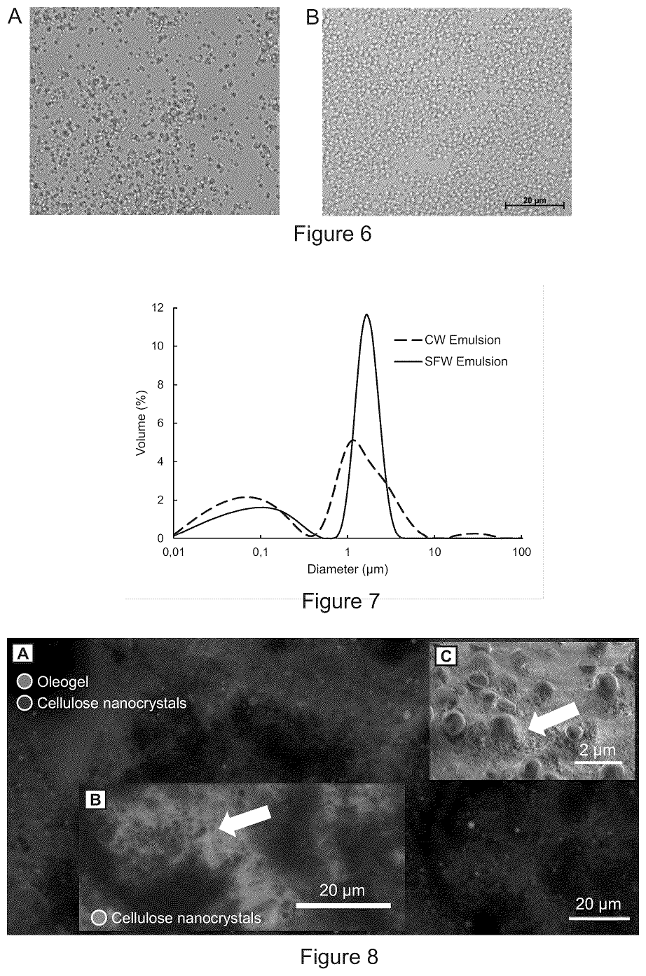

SFW oleogel-containing emulsion showed droplets with uniform diameter, whereas CW oleogel-containing emulsions showed heterogeneous droplet sizes (FIGS. 6A, 6B and 7). FIG. 6 shows optical microscopy images of emulsions containing 1% CNC, 160 mg NaCl and (A) 10% candelilla oleogel or (B) 10% sunflower oleogel. FIG. 7 illustrates the droplet size distribution of 10% candelilla oleogel emulsion (dashed line) and 10% sunflower oleogel emulsion (solid line).

Melting profile and x-ray diffraction results were comparable to those of bulk oleogels. X-ray diffraction also showed the presence of cellulose which was then located to be at the interface between the oleogel droplet and water using fluorescence microscopy and cryo-SEM (FIG. 8).

FIG. 8 shows (A) sunflower wax oleogel droplets (red) emulsified with cellulose nanocrystals (CNC, blue), (B) magnification of (A) showing oleogel droplets fully covered by CNC (grey, arrow), (C) cryogenic scanning electron microscopy image of oleogel droplets covered by CNC (arrow).

### Example 3

### Encapsulated Oleogel System

To determine the amount of fiber necessary to build up a proper capsule, we studied the effect of increasing ratio between the solid materials in the systems: CNC and SCF. To observe and quantify the effect of increasing proportions of SCF on the efficiency of the process, we tested four CNC:SCF ratios for each type of emulsion: 1:7, 1:14, 1:21, and 1:28. After preliminary trials to optimize the spray drying parameters, such as pump rate, inlet air temperature, and aspiration, we obtained the conditions that allowed us to recover sufficient material from the cyclone and collector in spray dryer.

FT-IR data showed that starting materials were present in all samples, indicating no loss of any material during the spray drying process.

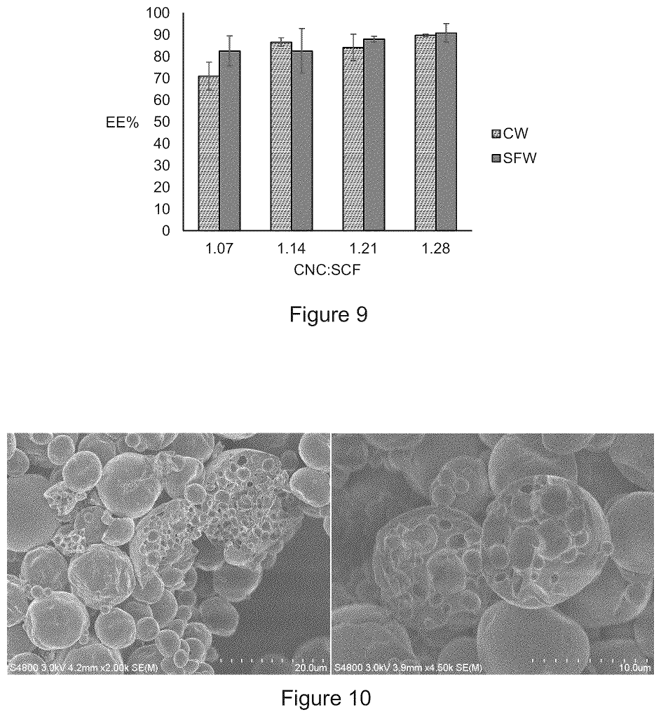

The resulting capsules showed a high encapsulation efficiency (EE), meaning that most of the droplets were inside the capsule (FIG. 9). The only samples that had an EE lower than 85% were those obtained with 1:7 CNC:SCF ratio and 1:14 SFW.

FIG. 9 illustrates the encapsulation efficiency (EE%) of 1:7 CW, 1:14 CW, 1:21 CW, 1:28 CW, 1:7 SFW, 1:14 SFW, 1:21 SFW and 1:28 SFW capsules. Note: CNC:SCF, as the ratio between the content of crystalline nanocellulose and soluble corn fiber. CW, candelilla wax. SFW, sunflower wax.

All capsules showed numerous enclosed droplets inside them, confirming the formation of multicore capsules. As an example, FIG. 10 shows crushed capsules for samples having 1:21 CNC:SCF ratio and containing SFW and CW oleogels.

FIG. 10 shows the internal morphology of (left) 1:21 SFW crushed capsules and (right) 1:21 CW crushed capsules visualized using field emission scanning electron micrograph.

The melting properties of encapsulated oleogels were like those of bulk oleogels. X-ray diffraction showed that waxes were able to organize in crystalline structures as those seen in bulk oleogels and emulsions, meaning that the oleogel was formed inside the droplets.

### Example 4

### Oleogel in Oleogel

A 5% monoglyceride (MG) oleogel containing a total of 15% of capsules containing sunflower seed wax (SFW) or candelilla wax (CW) oleogels was developed.

### Example 5

### In Vitro Digestion

Oil and emulsified oil (using Tween20—common emulsifier) release during in vitro digestion a total of around 61-63% fatty acids. Preliminary studies showed that encapsulated oleogel containing 21 times soluble corn fiber and sunflower seed wax oleogels reduced the release of fatty acids to around 38% (1:21 SFW capsules), showing a reduction of the oil digestion of around 40%.

Emulsions containing oleogels (SFW and CW) using resistant starch (two types: National 912 and Capsul) were also prepared. The total digestion was:
SFW National 912: 30%, reducing oil digestibility of about 52%
SFW Capsul: 37%, reducing oil digestibility of about 40%
CW National 912: 40%, reducing oil digestibility of about 36%
CW Capsul: 45%, reducing oil digestibility of about 28%.

In vitro digestion simulates the oral, gastric, and intestinal conditions during human digestion. The experiments here described were carried out using the INFOGEST 2.0 protocol for static in vitro digestion analysis (Brodkorb, A., et al., Nature Protocols, 2019. 14 (4): p. 991-1014). In vitro digestion method uses simulated digestive fluids and digestive enzymes and is carried out at 37° C. (body temperature). The protocol includes the subsequent addition of different digestive fluids and enzymes during the oral, gastric, and intestinal phases. The fluids used are simulated salivary fluid (SSF), simulated gastric fluid (SGF), and simulated intestinal fluid (SIF). Each fluid has a different ion concertation, composition, and pH value according to the INFOGEST 1.0 and 2.0 protocols (Brodkorb, A., et al., Nature Protocols, 2019. 14 (4): p. 991-1014; Minekus, M., et al., Food & Function, 2014. 5 (6): p. 1113-24). In particular, pH values are 7, 3, and 7 for SSF, SGF, and SIF, respectively and are adjusted using NaOH and HCl. During the oral phase, samples are mixed 1:1 with SSF and salivary amylase is added. This phase lasts for 2 min. Following, the gastric phase is started by mixing to the mixture SGF in 1:1 ratio and pepsin. This phase lasts for 2 h. Finally, the gastric chyme is mixed with SIF in 1:1 ratio and pancreatin (or individual trypsin, chymotrypsin, pancreatic lipase, colipase, and pancreatic amylase) and bile are added to the mixture. This phase lasts for 2 h. During the intestinal phase, during the simulated intestinal phase, triglyceride lipolysis kinetics was analyzed using the pH-stat method (Li, Y. and D. J. McClements, Journal of Agricultural and Food Chemistry, 2010. 58 (13): p. 8085-92). This method measures the fraction of free fatty acids released from triacylglycerols over time by titrating the intestinal chyme with NaOH solution using an automatic titrator.

### EXAMPLE 6

Compositions were prepared using the following protocol, wherein either a cold emulsification step or a hot emulsification step was included.
1. Optional: Heating 5 wt % ethylcellulose and 95 wt % oil (rape seed or sunflower etc.) to 160°° C. for 45 minutes or 180° C. for 15 minutes while mixing. Let it cool at room temperature for two hours. The product is viscous oil with lower digestibility.
2. HPMC (hydroxypropyl methylcellulose) solution is produced by dissolving 1-2 wt % HPMC in water overnight.
3. Cold emulsification step: 10-30 wt % oil (or the product of step 1 (viscous oil)) in 90-70 wt % HPMC solution is emulsified (Ultraturrax 13000 rpm for 2-5 minutes). There is no need for hot emulsification, microfluidization, and i bath. Hot emulsification step: same process as in the cold emulsification step, but the oil and HPMC solution will be heated to 70° C., and then the emulsification is done using the previously mentioned criteria. There is no need for microfluidization, and an ice bath.
4. A solution of 25 wt % of maltodextrin (MD with dextrose equivalent of 6) or fibers is prepared.
5. Cold process: The cold emulsion and cold fiber or MD solutions are mixed just before spray drying to contain one weight portion of oil and one-three weight portions of MD or fiber solution. Hot Process: MD or fiber solutions prepared in step 4 will be heated to 70° C. and mixed with hot emulsion before spray drying.
6. The mixture (cold or hot) goes through spray drying (170° C. inlet temperature, 100% aspiration, 35-55% pump speed).
7. The powder is sieved and collected at room temperature and in dry conditions.
8. 5-10 wt % monoglyceride in oil (rapeseed or sunflower etc.) is heated to 80°° C. for 5-10 minutes.
9. The powder obtained in the 7th step is added to the melted sample of the 8th step (in 40-60 wt %) and mixed well, then cooled at ambient temperature. If needed, the powders of the 7th step can be heated to 80° C. before being mixed with the melted sample of step 8.

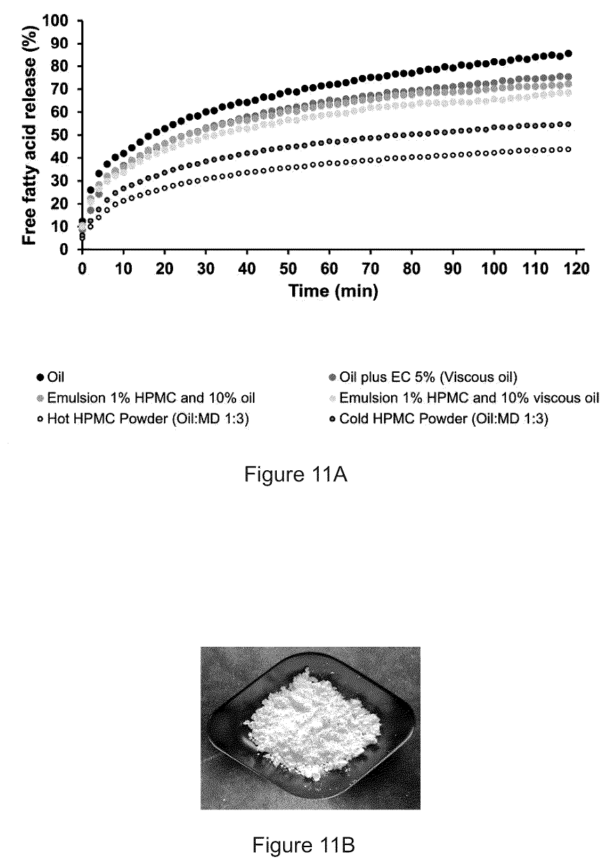

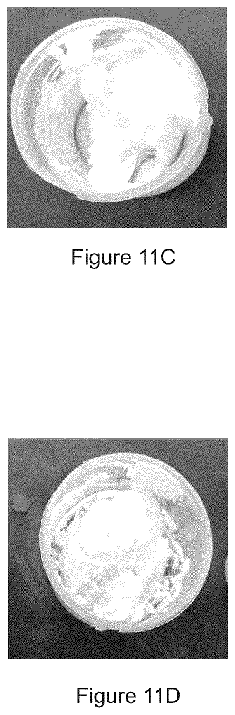

FIG. 11A shows the in vitro digestibility of liquid sunflower oil, oil plus ethylcellulose 5 wt % (viscous oil), cold emulsion (1 wt % HPMC and 10 wt % liquid oil), cold emulsion (1 wt % HPMC and 10 wt % viscous oil), hot HPMC powder (oil:maltodextrin=1:3 wt), and cold HPMC powder (oil:maltodextrin=1:3 wt).

FIG. 11B shows the spray dried powder made of cold emulsion (1 wt % HPMC and 10 wt % liquid oil) and maltodextrin (one portion oil plus three portion maltodextrin).

FIG. 11C illustrates a composition made of 40 wt % powder and 60 wt % oleogel (oleogel contains 10 wt % monoglyceride).

FIG. 11D shows a composition made of 60 wt % powder and 40 wt % oleogel (oleogel contains 10 wt % monoglyceride).

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A method, a product, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A composition comprising first solid or semi-solid fat or liquid or viscous oil composition droplets, wherein the first solid or semi-solid fat or liquid or viscous oil composition droplets comprise one or more of an at least partially indigestible or slowly digestible material, such that the first solid or semi-solid fat or liquid or viscous oil composition in the droplets is one or more of at least partially indigestible or slowly digestible.

2. The composition according to claim 1, the composition comprising encapsulated first solid or semi-solid fat or liquid or viscous oil composition droplets, wherein the first solid or semi-solid fat or liquid or viscous oil composition droplets are encapsulated in the one or more of at least partially indigestible or slowly digestible material.

3. The composition according to claim 1, wherein;
the first solid or semi-solid fat or liquid or viscous oil composition is an oleogel;
the droplets are dispersed in a second solid or semi-solid fat or liquid or viscous oil composition that is an oleogel; or
the first solid or semi-solid fat or liquid or viscous oil composition is a first oleogel, and the second solid or semi-solid fat or liquid or viscous oil composition is a second oleogel.

4. The composition according to claim 1, wherein the first solid or semi-solid fat or liquid or viscous oil composition is a first liquid or viscous oil composition; the first liquid or viscous oil composition droplets are encapsulated in the one or more of at least partially indigestible or slowly digestible material; and the droplets are dispersed in a second solid or semi-solid fat composition that is an oleogel.

5. The composition according to claim 1, wherein the first solid or semi-solid fat or liquid or viscous oil composition droplets are the one or more of at least partially indigestible or slowly digestible in the digestive system.

6. The composition according to claim 1, wherein the one or more of at least partially indigestible or slowly digestible material comprises or is cellulose; a cellulose derivative; resistant modified starch; xylan nanocrystals; chitosan; chitin nanocrystals; a microgel; starch; protein; alginate; microgelled particles; β-glucan; or any mixture or combination thereof.

7. The composition according to claim 1, wherein the first solid or semi-solid fat or liquid or viscous oil composition droplets are embedded in a reinforcing material.

8. The composition according to claim 1, wherein the first solid or semi-solid fat or liquid or viscous oil composition droplets comprise a vegetable wax; one or more of a saturated or unsaturated monoglyceride, one or more of a saturated or unsaturated diglyceride, a wax ester, a fatty alcohol, a fatty acid, a hydroxylated fatty acid, ceramide, lectin, sorbitan tristearate, a sphingolipid, an n-alkane, a phytosterol, cholesterol, a sterol ester, a stanol ester, ethylcellulose, cinnamic acid, a sucrose ester of a fatty acid; or any combination or mixture thereof.

9. The composition according to claim 1, wherein the droplets are dispersed in a second solid or semi-solid fat or liquid or viscous oil composition, and a mass ratio of the first solid or semi-solid fat or liquid or viscous oil composition and the second solid or semi-solid fat or liquid or viscous oil composition is in a range of 1-70% (w/w).

10. The composition according to claim 1, wherein the composition is a powder comprising the first solid or semi-solid fat or liquid or viscous oil composition droplets.

11. The composition according to claim 1, wherein at least 10% of the first solid or semi-solid fat or liquid or viscous oil composition droplets are indigestible in a digestive system.

12. A food product comprising or prepared using the composition according to claim 1.

13. The food product according to claim 12, wherein the food product is a margarine; a spread; a spreadable chocolate paste; a chocolate-type product; a bakery product; a meat alternative; a dairy alternative; a cheese; a plant-based drink; or an instant food powder.

14. A method for producing a composition according to claim 1, wherein the method comprises forming droplets comprising a first solid or semi-solid fat or liquid or viscous oil composition; wherein
the droplets are formed in a presence of the one or more of an at least partially indigestible or slowly digestible material; and
forming a powder of the droplets, the powder comprising the droplets.

15. The method according to claim 14, wherein the method comprises forming an emulsion comprising a first solid or semi-solid fat or liquid or viscous oil composition in the form of droplets in water or an aqueous solution; wherein one or more of:
the emulsion is formed in a presence of the one or more of at least partially indigestible or slowly digestible material, or
wherein the one or more of at least partially indigestible or slowly digestible material is added to the droplets; and
removing the water or the aqueous solution at least partially, thereby forming a powder comprising the droplets.

16. The composition according to claim 1 for use in activating an ileal brake ain a subject, controlling or reducing a body weight of the subject.

17. Use of the composition according to claim 1 for controlling or reducing a body weight of a subject.
